(19) United States
(12) Patent Application Publication
(10) Pub. No.: US 2017/0028932 A1
(43) Pub. Date: Feb. 2, 2017

(54) LIQUID STORAGE APPARATUS WITH INTEGRAL VEHICLE ATTACHMENT STRUCTURE

(71) Applicant: Adam E. Slank, Austin, TX (US)

(72) Inventor: Adam E. Slank, Austin, TX (US)

(21) Appl. No.: 14/815,963

(22) Filed: Aug. 1, 2015

(51) Int. Cl. B60R 9/06; B62D 43/00; B67D 3/00

(52) U.S. Cl. CPC B60R 9/06; B67D 3/0061; B62D 43/005

(57) ABSTRACT

A liquid storage apparatus mountable over a rear-mounted spare tire of a vehicle comprises a liquid storage bladder including an interior space for having liquid stored therein and a tire cover having a bladder compartment and a vehicle tire compartment adjacent to the bladder compartment. The liquid storage bladder is within an interior space of the bladder compartment. The tire cover includes a spare tire mount passage in a wall thereof defining an interior space of the vehicle tire compartment. The bladder compartment is opposite the spare tire mount passage.

### FIELD OF THE DISCLOSURE

The disclosures made herein relate generally to mobile liquid storage apparatuses for water and the like and, more particularly, to a liquid storage apparatus with integral vehicle attachment structure.

### BACKGROUND

It is well known that adequate hydration is critical in maintaining the body's homeostasis. It is also well known that maintenance of adequate hydration becomes both more important and more difficult as the duration of a strenuous physical activity increases. As such, it is common for persons involved in activities that promote dehydration to carry fluids to replace those lost during such activities.

For some activities, a person can readily carry a suitable volume of liquid required for his or her own personal hydration needs. For example, when a reliable source of fluid replenishment is known, a person can a suitable volume of water in a water bottle, personal hydration pack, or the like. However, in situations where it is not viable to rely on reaching a destination having such reliable source of fluid replenishment (e.g., water and/or fuel) and/or when it is not practical for an individual to carry necessary fluid thereon for a possible duration of activity or distance of travel (e.g., water), it is often essential to carry fluid reserves.

One such means for carry fluid reserves is to carry containers of fluid such as water (or fuel) on a vehicle used for transporting the person(s). For example, it has been documented that members of the British military's Special Air Service ('S.A.S.”) conducted missions in the Sahara deserts of Africa and, due to the extreme environment and inability to rely on a remote source of water for replenishment, it was essential to carry adequate supplies of water for their mission. To this end, they resorted to carrying water on multiple locations inside and outside of their transport vehicles. To optimize the capacity of water that they carried, they were known to sometimes fill the vehicle's rear mounted spare tire itself with water instead of air, even though this would prevent the full use of the spare tire if it were needed for replacement.

Although the use of the spare tire as a liquid storage apparatus allowed the tire to serves two essential purposes, the volume formed within a tire mounted on a wheel is not suitably configured for storing water that is intended to be used for human consumption and may otherwise contaminate liquids not intended for human consumption. For example, contaminants from the tire and wheel (e.g., rubber, metal, oils and the like) would affect the taste and health of the water and was exacerbated by high ambient temperatures and exposure of the tire/wheel to direct sunlight. Additionally, this approach to transporting water generally required the removal of a tire cover, if one was being used, in order to access the water inside the tire. Still further, storing flue in a tire may lead to its contamination and subsequent inoperability of an engine in which such fuel is used.

Therefore, a liquid storage apparatus that is located at the same location as an externally mounted spare tire of a vehicle but that overcomes drawbacks of using a space within the mounted spare tire would be advantageous, desirable and useful.

### SUMMARY OF THE DISCLOSURE

Embodiments of the present invention are generally directed to vehicle-mounted liquid storage apparatuses. More specifically, embodiments of the present invention are directed to a liquid storage apparatus that is located at the same location as an externally mounted spare tire of a vehicle. Embodiments of the present invention are not limited to a particular type of liquid, whereby liquids such as water, fuel or the like can be carried therein.

Other than the obvious constraints of volume and weight, there is never too much clean drinking water at hand in an austere environment. One reason for this is that water is essential to human life and the ability to carry additional amounts of water on a vehicle, that otherwise would not have been possible, will aid survival in many parts of the world. To this end, a liquid storage apparatus configured in accordance with the present invention will have an interior space that does not expose water contained therein to contaminants (e.g., shields water from thermal heating) and can be configured to insulate the water from ambient conditions and to isolate the water from ambient exposure (e.g., water removed only through one-way valve).

In preferred embodiments, a liquid storage apparatus configured in accordance with the present invention is specifically configured for storing and dispensing water intended for human consumption for purposes. For example, such a liquid storage apparatus can be configured as a hydration bladder that is mounted externally on a vehicle for use by individuals operating in an austere environment thereby allowing for storage, transport, and dispensing of drinking water to individuals from spare tire area of the vehicle. In this respect, such a liquid storage apparatus will provide for a sizeable volume of water to be carried, but without consuming interior storage space in the vehicle while allowing the water to be easily dispensed such as by way of a gravity-feed dispensing arrangement to a container (e.g., water bottle, canteen, or personal hydration pack) that is located at a level below an outlet of the liquid storage apparatus thereby ensuring a flow of water under the force of gravity.

Advantageously, a liquid storage apparatus configured in accordance with the present invention allows for easy to dispense liquid using gravity while still attached to a vehicle. This precludes the necessary acts of lifting, tilting, and pouring required by a conventional fluid containment container such as a water jug. Furthermore, such a liquid storage apparatus is compact and uses an external storage area of the vehicle, where storage space is more abundant and underutilized.

Advantageously, a liquid storage apparatus configured in accordance with an embodiment of the present invention have a fluid storage bladder that reduces its volume when as its contents are dispensed. For example, the fluid storage bladder can be made from a flexible material, have structure (e.g., bellows that allow for expansion/contraction, and/or the like. In this respect, space required for storage of the liquid storage apparatus is reduced when the bladder is empty and, thus, occupies much less space than storage of an empty rigid container of comparable usable volume.

In one embodiment of the present invention, a liquid storage apparatus mountable over a rear-mounted spare tire of a vehicle comprises a liquid storage bladder including an interior space for having liquid stored therein, a bladder enclosure having an interior space with the liquid storage bladder therein, and a mounting structure extending from the bladder enclosure. The mounting structure includes an interior space with size and shape suitably configured for having a motor vehicle tire disposed therein.

In another embodiment of the present invention, a liquid storage apparatus mountable over a rear-mounted spare tire of a vehicle comprises a liquid storage bladder including an interior space for having liquid stored therein and a tire cover having a bladder compartment and a vehicle tire compartment adjacent to the bladder compartment. The liquid storage bladder is within an interior space of the bladder compartment. The tire cover includes a spare tire mount passage in a wall thereof defining an interior space of the vehicle tire compartment. The bladder compartment is opposite the spare tire mount passage.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing a liquid storage apparatus configured in accordance with an embodiment of the present invention attached to a prior art motor vehicle spare tire.

FIG. 2 is a partially fragmentary side view of the liquid storage apparatus shown in FIG. 1.

FIG. 3 is a rear view of the liquid storage apparatus shown in FIG. 1.

### DETAILED DESCRIPTION

Embodiments of the present invention can be implemented as a liquid storage bladder carrying tire cover that attaches to the externally mounted spare tire of a vehicle. The tire cover protects the tire and wheel from the outside elements and may provide some internal and external storage for small items. Advantageously, such a liquid storage bladder carrying tire cover includes the addition of a separate, protected, internal compartment for a bladder of fluid with a fluid dispensing structure (e.g., a hose with a flow control valve). The fluid dispensing structure can be fixedly positioned through an opening in the tire cover or can be selectively extended through such an opening in the tire cover. Preferably, but not necessarily, a compartment off the tire cover in which the bladder is located provides for protection to prevent the puncture of the hydration bladder and optionally insulation of the bladder for temperature control of the fluid contents of the bladder.

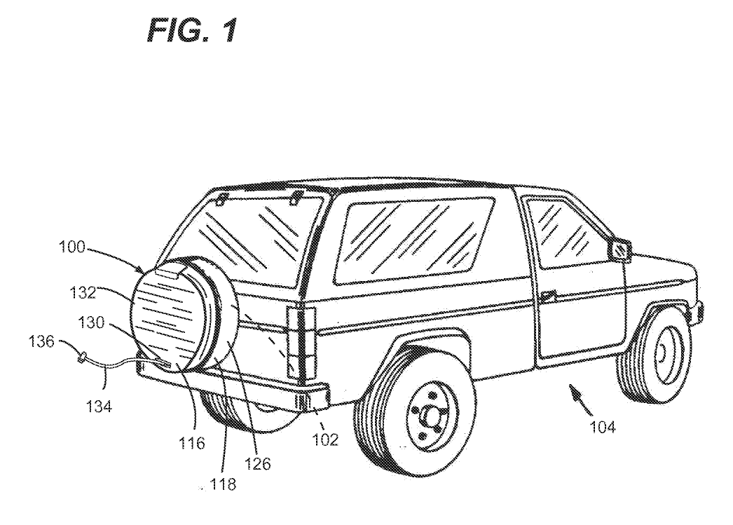

Turning now to the drawing figures, FIGS. 1-3 show a liquid storage apparatus 100 configured in accordance with an embodiment of the present invention. The liquid storage apparatus 100 mountable over a rear-mounted spare tire 102 (prior art) of a motor vehicle 104 (prior art). To this end, the liquid storage apparatus 100 includes a tire cover 110 and a liquid storage bladder 112 (i.e., a fluid storage container). The liquid storage bladder 112 includes an interior space 114 for having liquid stored therein. The tire cover 110 has a bladder compartment 116 (i.e., a bladder enclosure) and a vehicle tire compartment 118 (i.e., a mounting structure) adjacent to the bladder compartment 116. The tire cover can be made from a compliant and/or flexible material such as a woven nylon fabric. A divider 119, such as made from a substantially compliant material or a substantially rigid material, defines a wall that at least partially separates the bladder compartment 116 from the vehicle tire compartment 118. The liquid storage bladder 112, which can be made from a flexible and substantially water impermeable polymeric material, is within an interior space 120 of the bladder compartment 116.

The tire cover 110 includes a spare tire mount passage 122 in a rear wall 124 of the tire cover 110. The rear wall 124 of the tire cover, a side wall 126 of the tire cover 110, and the divider 119 jointly define an interior space 128 of the vehicle tire compartment 118. The spare tire mount passage 122 is suitably configured for allowing a spare tire mount 129 of the vehicle 104 to pass through the rear wall 124 of the tire cover 110. The bladder compartment 116 is opposite the spare tire mount passage 122.

The tire cover 110 can be secured to the spare tire 102 of the motor vehicle 104 using various approaches. One such approach for securing tire cover 110 to the spare tire 102 involves the tire cover 110 including a tire insertion passage 127 in the rear wall 124 that defines the interior space 126 of the vehicle tire compartment 118 for allowing the spare tire 102 to be positioned within the interior space 126 of the vehicle tire compartment 118 through the tire insertion passage 127 when the tire insertion passage 127 is in a tire insertion configuration (i.e., perimeter edges of the tire insertion passage 127 in a spaced apart orientation). A closure device 131 such as a zipper or drawstring (not shown) spanning the tire insertion passage 127 provides for the tire insertion passage 127 to be selectively transitioned between the tire insertion configuration and a tire containment configuration (i.e., perimeter edges of the tire insertion passage 127 drawn toward each other). One such approach for securing tire cover 110 to the spare tire 102 involves a cinchable member such as a drawstring, cable, cord, rope or the like, which serves as the closure device 131, being attached to the rear wall 124 in a manner whereby the cinchable member fully or partially encircling the spare tire mount passage 122. The cinchable member can thereby be used to cinch the spare tire mount passage 122 to draw the rear wall 124 of the tire cover, the side wall 126 of the tire cover 110, and the divider 119 into engagement with the spare tire 102 (e.g., gathers an open end of the tire cover 110 behind the tire 102), thereby urging the vehicle tire compartment 118 into a size and shape limited by (e.g., generally the same as) the size and shape of the spare tire 102. In this respect, the rear wall 124 of the tire cover, the side wall 126 of the tire cover 110, and the divider 119 jointly define a mounting structure of the tire cover 110 having an interior space with size and shape suitably configured for having a motor vehicle tire disposed therein.

It is desirable for the bladder compartment 116 and the vehicle tire compartment 118 to be arranged in a manner that optimizes space occupied by the tire cover 110 and that maximizes fluid volume of the liquid storage bladder 112. To this end, the liquid storage bladder 112 can have an overall shape that is substantially the same as that the spare tire 102 (i.e., a generally flat round shape). More specifically, in some embodiments, the tire cover 110 has a substantially circular exterior profile (e.g., cylindrical exterior side wall) and the bladder compartment 116 and the vehicle tire compartment 118 are substantially concentric with each other (i.e., a axially stacked compartment arrangement).

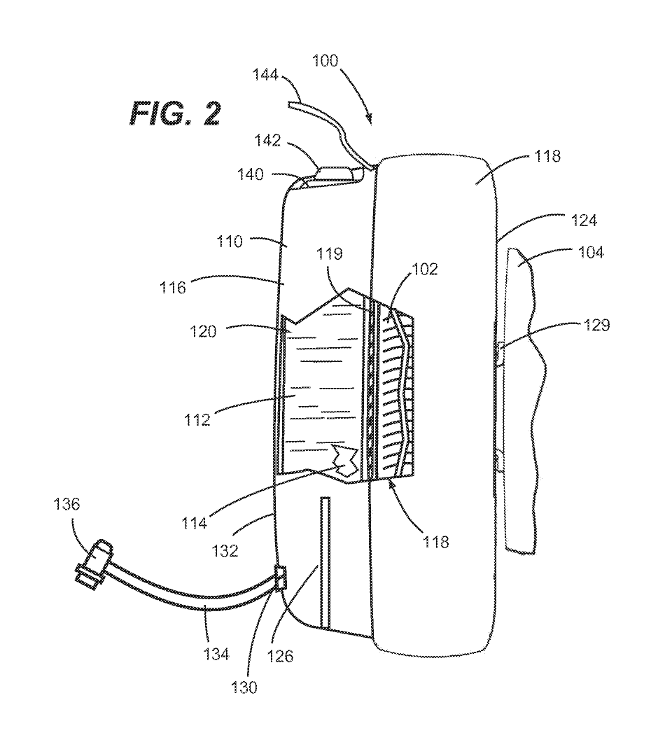

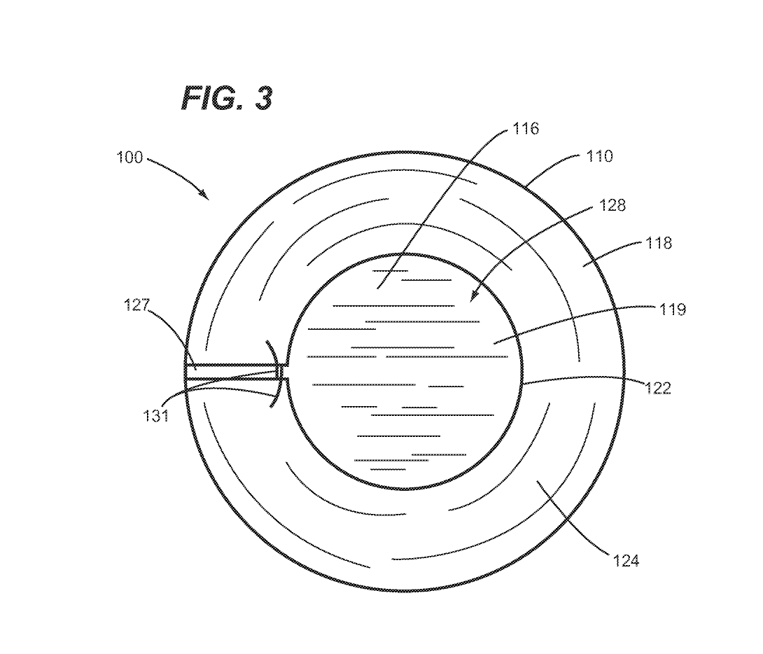

Preferably, the tire cover 110 and the liquid storage bladder 112 are jointly configured for allowing liquid within the liquid storage bladder 112 to be readily and conveniently dispensed with the liquid storage apparatus 100 mounted on the spare tire 102. To this end, in one embodiment, a liquid dispenser opening 130 is provided in a front wall 132 of the tire cover 110, as best shown in FIGS. 2 and 3. In preferred embodiments, the liquid dispenser opening 130 is adjacent to a lower edge portion of the front wall 132 of the tire cover 110. The front wall 132 of the tire cover 110 and the side wall 126 of the tire cover 110 jointly define the interior space 120 of the bladder compartment 116. A liquid dispensing hose 134 is attached to the liquid storage bladder 112 and is in fluid communication with the interior space 114 of the liquid storage bladder 112, as best shown in FIG. 5. The liquid dispenser hose 134 is of sufficient length for allowing an end portion of the liquid dispensing hose 134 having a fluid dispensing control valve 136 mounted thereon to be extended through the liquid dispenser opening 130. Alternatively, the fluid dispensing control valve 136 can be attached directly to the liquid storage bladder 112 and extend through the liquid dispenser opening 130. In this respect, the liquid storage apparatus 100 includes a liquid dispenser that extends through the liquid dispenser opening 130.

In preferred embodiments, the tire cover 110 includes a filling port opening 138 adjacent to an upper edge portion of the front wall 130 of the tire cover 110 and the includes a filler port structure 142 (e.g., fluid inlet with cap) in fluid communication with the interior space 114 of the liquid storage bladder 112. A cover 144 such as a flat of material can cover the filling port opening 138. The liquid dispensing hose 134 is positioned adjacent to the liquid dispenser opening 130 for allowing the liquid dispenser to be accessed through the liquid dispenser opening 130 and/or the fluid dispensing control valve 136 to be located within the liquid dispenser opening. The filler port structure 142 is positioned adjacent to the filling port opening 138 for allowing the filler port structure 142 to be accessed through the filling port opening 138 and/or the filler port structure 142 to be located within the filling port opening 138.

Advantageously, a liquid storage apparatus configured in accordance with an embodiment of the present invention have a storage bladder that reduces its volume when its contents are dispensed. In this respect, space required for storage of the liquid storage apparatus is reduced when the bladder is empty and, thus, occupies much less space than storage of an empty rigid container of comparable usable volume.

It is disclosed herein that a liquid storage apparatus configured in accordance with an embodiment of the present invention can have a tire cover with a fluid storage container compartment having a plurality of liquid storage containers therein. It is also disclosed herein that a liquid storage apparatus configured in accordance with an embodiment of the present invention can have tire cover with multiple axially stacked, side-by-side, or concentrically arranged fluid storage container compartments each with a respective fluid storage container located therein. Still further, it is disclosed herein that a liquid storage apparatus configured in accordance with an embodiment of the present invention can have a tire cover with a fluid storage container compartment having a multi-chamber liquid storage container therein. In such embodiments, each one of the fluid storage containers or each chamber of a multi-chamber liquid storage container can have a respective fluid dispenser extending through a dedicated or shared opening in the tire cover thereby allowing for selective and independent dispensing of fluid from each one of the fluid storage containers or each chamber of the multi-chamber liquid storage container.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

What is claimed is:

1. A liquid storage apparatus mountable over a rear-mounted spare tire of a vehicle, comprising:
a liquid storage bladder including an interior space for having liquid stored therein;
a bladder enclosure having an interior space with the liquid storage bladder therein; and
a mounting structure extending from the bladder enclosure, wherein the mounting structure includes an interior space with size and shape suitably configured for having a motor vehicle tire disposed therein.

2. The liquid storage apparatus of claim 1 wherein:
the bladder enclosure has a substantially circular exterior profile;
the mounting structure has a substantially circular exterior profile; and
the bladder enclosure and the mounting structure are substantially concentric with each other.

3. The liquid storage apparatus of claim 1 wherein:
the mounting structure includes a spare tire mount passage in a wall thereof defining the interior space of the mounting structure; and
the bladder enclosure is located opposite the spare tire mount passage.

4. The liquid storage apparatus of claim 1 wherein:
the bladder enclosure includes a liquid dispenser opening in a wall thereof defining the interior space of the bladder enclosure;
the liquid storage bladder includes a liquid dispenser attached thereto and in fluid communication with the interior space of the liquid storage bladder; and
at least a portion of the liquid dispenser extends through the liquid dispenser opening.

5. The liquid storage apparatus of claim 1 wherein:
the bladder enclosure includes a liquid dispenser opening in a wall thereof defining the interior space of the bladder enclosure;
the liquid storage bladder includes a liquid dispenser hose attached thereto and in fluid communication with the interior space of the liquid storage bladder; and
the liquid dispenser hose is of sufficient length for allowing an end portion thereof to be extended through the liquid dispenser opening.

6. The liquid storage apparatus of claim 1 wherein:
the bladder enclosure includes a liquid dispenser opening adjacent to a lower edge portion of a wall thereof defining the interior space of the bladder enclosure and a filling port opening adjacent to an upper edge portion of a wall thereof defining the interior space of the bladder enclosure;
the liquid storage bladder includes a liquid dispenser and a filler port structure;
the liquid dispenser and the filler port structure are in fluid communication with the interior space of the liquid storage bladder;
the liquid dispenser is positioned adjacent to the liquid dispenser opening for allowing at least one of the liquid dispenser to be accessed through the liquid dispenser opening and the liquid dispenser to be located within the liquid dispenser opening; and
the filler port structure is positioned adjacent to the filling port opening for allowing at least one of the filler port structure to be accessed through the filling port opening and the filler port structure to be located within the filling port opening.

7. The liquid storage apparatus of claim 6 wherein:
the tire cover includes a spare tire mount passage in a wall thereof defining the interior space of the mounting structure; and
the bladder enclosure located is opposite the spare tire mount passage.

8. The liquid storage apparatus of claim 6 wherein:
the filling port opening is in a side wall of the bladder enclosure; and
the liquid dispenser opening is in one of the side wall of the bladder enclosure and an end face wall of the bladder enclosure.

9. The liquid storage apparatus of claim 6 wherein:
the bladder enclosure includes a bladder access opening in a wall thereof defining the interior space of the bladder enclosure; and
the bladder access opening is suitably sized for allowing the bladder to be unitarily removed from within and placed into the interior space of the bladder enclosure.

10. The liquid storage apparatus of claim 9 wherein:
the filling port opening is in a side wall of the bladder enclosure;
the mounting structure is attached to and extends from the side wall of the bladder enclosure.

11. The liquid storage apparatus of claim 10 wherein:
the bladder enclosure has a substantially circular exterior profile;
the mounting structure has a substantially circular exterior profile; and
the bladder enclosure and the mounting structure are substantially concentric with each other.

12. A liquid storage apparatus mountable over a rear-mounted spare tire of a vehicle, comprising:
a liquid storage container including an interior space for having liquid stored therein; and
a tire cover having a fluid storage container compartment and a vehicle tire compartment adjacent to the fluid storage container compartment, wherein the liquid storage container is within an interior space of the fluid storage container compartment, wherein the tire cover includes a spare tire mount passage in a wall thereof defining an interior space of the vehicle tire compartment, and wherein the fluid storage container compartment is opposite the spare tire mount passage.

13. The liquid storage apparatus of claim 12 wherein:
the tire cover has a substantially circular exterior profile; and
the fluid storage container compartment and the vehicle tire compartment are substantially concentric with each other.

14. The liquid storage apparatus of claim 12 wherein:
the tire cover includes a liquid dispenser opening in a wall thereof defining the interior space of the fluid storage container compartment;
the liquid storage bladder includes a liquid dispenser attached thereto and in fluid communication with the interior space of the liquid storage container; and
at least a portion of the liquid dispenser extends through the liquid dispenser opening.

15. The liquid storage apparatus of claim 12 wherein:
the tire cover includes a liquid dispenser opening in a wall thereof defining the interior space of the fluid storage container compartment;
the liquid storage bladder includes a liquid dispenser hose attached thereto and in fluid communication with the interior space of the liquid storage container; and
the liquid dispenser hose is of sufficient length for allowing an end portion thereof to be extended through the liquid dispenser opening.

16. The liquid storage apparatus of claim 12 wherein:
the tire cover includes a liquid dispenser opening adjacent to a lower edge portion of a wall thereof defining the interior space of the fluid storage container compartment and a filling port opening adjacent to an upper edge portion of a wall thereof defining the interior space of the fluid storage container compartment;
the liquid storage bladder includes a liquid dispenser and a filler port structure;
the liquid dispenser and the filler port structure are in fluid communication with the interior space of the liquid storage container;
the liquid dispenser is positioned adjacent to the liquid dispenser opening for allowing at least one of the liquid dispenser to be accessed through the liquid dispenser opening and the liquid dispenser to be located within the liquid dispenser opening; and
the filler port structure is positioned adjacent to the filling port opening for allowing at least one of the filler port structure to be accessed through the filling port opening and the filler port structure to be located within the filling port opening.

17. The liquid storage apparatus of claim 16 wherein:
the filling port opening is in a side wall of the tire cover; and
the liquid dispenser opening is in one of the side wall of the tire cover and an end face wall of the tire cover.

18. The liquid storage apparatus of claim 16 wherein:
the tire cover includes a bladder access opening in a wall thereof defining the interior space of the fluid storage container compartment; and
the bladder access opening is suitably sized for allowing the fluid storage container to be unitarily removed from within and placed into the interior space of the fluid storage container compartment.

19. The liquid storage apparatus of claim 16 wherein:
the tire cover has a substantially circular exterior profile; and
the fluid storage container compartment and the vehicle tire compartment are substantially concentric with each other.

20. The liquid storage apparatus of claim 19 wherein:
the filling port opening is in a side wall of the tire cover; and
the liquid dispenser opening is in one of the side wall of the tire cover and an end face wall of the tire cover.
